(19) United States
(12) Patent Application Publication
(10) Pub. No.: US 2011/0007737 A1
(43) Pub. Date: Jan. 13, 2011

(54) DELIVERY OF MEDIA STREAMING SERVICES IN A MOBILE COMMUNICATION SYSTEM

(76) Inventors: Alain Bultinck, Nozay (FR); Laurent Thiebaut, Nozay (FR)

Correspondence Address: FAY SHARPE/LUCENT, 1228 Euclid Avenue, 5th Floor, The Halle Building, Cleveland, OH, 44115-1843, US

(21) Appl. No.: 12/741,775

(22) PCT Filed: May 12, 2008
(86) PCT No.: PCT/IB2008/053465

§ 371 Date: Sep. 9, 2010

Related U.S. Application Data
(60) Provisional application No. 61/002,084, filed on Nov. 6, 2007.

(51) Int. Cl. H04L 12/66

(52) U.S. Cl. 370/355

(57) ABSTRACT

One object of the present invention, in an embodiment, is a method for the delivery of media streaming services to a User Equipment in a mobile communication system having a Core Network comprising a Circuit Switched CS domain, an IP network, and at least one interworking entity between said CS domain and said IP network, said method comprising the steps of:
establishing a call through the CS domain towards a Remote User Agent acting on behalf of the User Equipment in the IP network,
establishing a streaming session with a Streaming Server via the Remote User Agent,
said call establishment interacting with said streaming session establishment to enable the delivery of streaming services to the User Equipment for said streaming session through the CS domain using CS bearer established during said call establishment.

This application is a U.S. National Filing of International Application Serial No. PCT/IB2008/053465, filed May 12, 2008, which claims priority to U.S. Provisional Application Ser. No. 61/002,084, filed on Nov. 6, 2007.

### FIELD OF THE INVENTION

The present invention generally relates to mobile communication networks and systems.

### BACKGROUND

Detailed descriptions of mobile communication networks and systems can be found in the litterature, in particular in Technical Specifications published by standardisation bodies such as for example 3GPP (3^{rd} Generation Partnership Project).

In such systems, a Mobile Station or User Equipment has access, via an Access Network (AN), to services provided by a Core Network (CN).

There are different types of services which can be provided by the Core Network, such as in particular CS (Circuit Switched) based services, PS (Packet Switched) based services, and IP (Internet Protocol) based services such as in particular IMS (IP Multimedia Subsystem) services. The Core Network (CN) therefore comprises different domains and subsystems such as in particular CS domain, PS domain, and IMS subsystem. IP based services are provided via an operator's IP network to which the user generally connects via the PS domain providing IP connectivity.

There are different types of services which can be delivered to a user, such as in particular real time services, including conversational services (such as in particular telephony or video telephony), and streaming services (enabling for example a User Equipment to receive audio and/or video streams from Streaming Server(s)).

Services are delivered to users using bearers (such as for example CS bearers in CS domain, or IP bearers in IP network) established using call or session control protocols such as for example ISUP (ISDN User Part) or BICC (Bearer Independent Call Control) in CS domain, or SIP (Session Initiation Protocol) in an IP network such as for example IMS network.

While conversational services have traditionally been delivered via CS domain, trend in mobile communication environment is to provide more and more user services through the PS domain (in fact above the IP access gateway or over the “IPCAN (IP Connectivity Access Network) gateway” to take the 3GPP vocabulary) in IMS/sip or other IP service environment. The objective being in fine to centralize maximum of user services (new multimedia services, but also the legacy telephony service) in IMS environment. This will facilitate service development and operation for operators.

But currently deployed packet domain radio (e.g. GSM GPRS or UMTS PS domains) are not adapted to support efficiently conversational services. To work around this issue and continue to promote unification of services in IMS domain, operators and manufacturers are pushing in standardization for new mobile telephony architecture where the Telephony Application is provided in IMS environment (by a so called “TAS” or “Telephony Application Server”) while user bearer remains in the circuit switched environment domain (GSM or UMTS CS for example): the “old” CS switching domain being used in this case only for establishing (over legacy CS domain and associated Radio Access Network) the CS bearer up to the IMS domain where the actual service environment (TAS application) is located.

One of the most popular architectures to realize that is the so called “IMS Centralized Services (ICS)” architecture where the UE is in relation with a RUA “Remote UA” (in fact Remote SIP User Agent) in IMS environment: for a terminal connected to the network via legacy radio not adapted to support efficiently conversational services, the RUA both exchanges sip signaling with the IMS/sip service environment on behalf of this terminal and manages the “user call leg” established to carry the user plane traffic of this terminal from/to the IMS backbone. In particular case where the UE has no possibility to access simultaneously CS and PS domain (that is commonly the case in GSM/GPRS environment), mobile/RUA exchanges are realized through a dedicated signaling protocol over the CS USSD (Unstructured Supplementary Service Data) channel.

But in the future, it is expected that IMS rich environment will facilitate the development of more complex applications involving both TAS and voice/video streaming services (for example a audio/video surveillance application able to switch from streaming surveillance to conversational dialog with the visitor). This means the mobile is able to switch rapidly between SIP and RTSP protocol (the IETF standard Real Time Streaming Protocol) to pilot alternatively streaming and conversational functions.

### SUMMARY

As recognized by the inventors, this causes some problems when the voice conversational service is provided through CS domain if the streaming service remains delivered only through the PS domain, in particular:
For mobiles that do not have dual parallel access to CS and PS domains possibility, for GSM environment where DTM facility (Dual Transfer Mode) is not available in the mobile or in the network, this will involve an unacceptable switching time between the two functions (due to the time to establish a PDP context to access the streaming function of the enhanced application and time to establish the CS bearer toward the IMS gateway to access the TAS function of the enhanced application),
For mobiles with evolved UMTS CS video telephony facility (that automatically have parallel CS/PS access capability) a switch from CS to PS to access streaming function will cause waste of resources both in the Radio and the Core Network due to:

parallel resource reservation in the PS domain and CS domain to mask the switching time

H.223 CS multiplex technology that is more efficient to convey low speed audio/video multimedia flows compared to the PS multiplexing technology based on IP/RTP.

Embodiments of the present invention in particular enables to solve such problems, and/or to avoid such drawbacks. More generally, embodiments of the present invention enable to improve service delivery in such systems.

These and other objects are achieved, in one aspect of the present invention, in an embodiment, by a method for the delivery of media streaming services to a User Equipment in a mobile communication system having a Core Network comprising a Circuit Switched CS domain, an IP network, and at least one interworking entity between said CS domain and said IP network, said method comprising the steps of:
establishing a call through the CS domain towards a Remote User Agent acting on behalf of the User Equipment in the IP network,
establishing a streaming session with a Streaming Server via the Remote User Agent,
said call establishment interacting with said streaming session establishment to enable the delivery of streaming services to the User Equipment for said streaming session through the CS domain using CS bearer established during said call establishment.

These and other objects are achieved, in another aspect of the present invention, in an embodiment, by a User Equipment comprising means for performing such method.

These and other objects are achieved, in another aspect of the present invention, in an embodiment, by a Remote User Agent for performing such method.

### BRIEF DESCRIPTION OF THE DRAWINGS

Some embodiments of apparatus and/or methods in accordance with embodiments of the present invention are now described, by way of example only, and with reference to the accompanying drawings, in which:

FIG. 1 is intended to illustrate an example of system in which embodiments of the present invention can be used,

FIG. 2 is intended to illustrate an example of operation of the system illustrated in FIG. 1,

FIG. 3 is intended to illustrate an example of application of embodiments the present invention.

### DESCRIPTION OF EMBODIMENTS

Embodiments of the present invention proposed to provide a RTSP Remote UA (User Agent) function in order for the mobile to be able to benefit from streaming voice and video services through the Circuit Switched domain.

This function in the network communicates with the mobile user through an interface called “I1 bis interface” that can be either based on IMS/SIP (over PS domain) (I1 bis-PS) or on USSD (I1 bis-CS) in case the mobile cannot access simultaneously CS and PS domain (no DTM (Dual Transfer Mode) radio functionality is available).

The RTSP RUA is identified through a IMS PSI (Public Service Identifier) that allows to establish a call leg between the UE and the RTSP RUA (via the circuit radio, the MSC, and a MGCF/MG (Media Gateway Control Function/MediaGateway) that ensures inter-working between CS domain and IMS/sip signaling and user plane).

A UE wanting to benefit from the RTSP service through CS domain establishes a CS call towards the RTSP RUA (E164 called Number=RUA PSI). The user plane IP termination of this call leg will represent the RTSP client user plane IP transport termination for all future RSTP connections with Streaming server(s). This user plane IP transport termination is the IP address/port number chosen by the MGW associated with the MGCF. The UE establishes after the adequate I1 bis signaling plane with the RUA.

The role of the RTSP RUA is after to aggregate information received from I1bis and knowledge about the MGW IP transport termination(s) to send RTSP commands to the target streaming server. For example I1 bis could be based on RTSP commands without the IP/port address of the client, the RUA completing the commands with the IP/port address chosen by the MGW.

The user plane flow from the Streaming server to the UE is composed with a IP/RTP segment from the Streaming server to the MGW and a CS segment between the MGW and the UE.

The service being offered can be “voice only” if the CS call is of voice type or “multimedia” if the CS call is multimedia (UMTS with H.324m facility

This “RTSP RUA stand alone” solution offers the possibility to deliver Streaming services through the CS domain.

The following describes embodiments of this stand alone solution that focus on the cases where:
The terminal is a legacy 2G one that uses a “voice only” CS bearer. In this case, it can activate a voice stream facility with the help of the RTSP RUA. The CS/IMS interworking function is provided by a 3GPP R6 MGCF/MGW entity with voice interworking facility
The terminal is a 3G equipment with a H.324m video telephony application and can establish a BS30 CS bearer (CS bearer able to support H.223 multimedia multiplex). With the help of a enhanced 3GPP R7 visiophony capable MGCF/MGW as described in the R7 3GPP 26.114 specification chapter 12.2 (IMS multimedia telephony service, release 7, chapter on interworking with H.324m visiophony service), the terminal can activate voice and audio stream facilities with the help of the RTSP RUA.

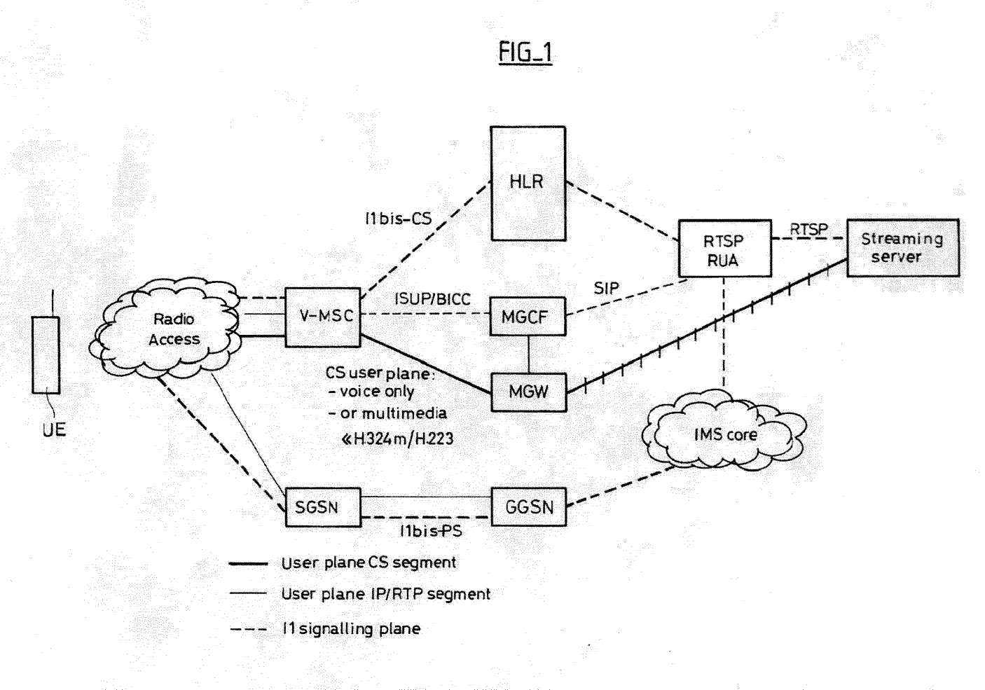

An example of system in which embodiments of the present invention can be used is illustrated in FIG. 1. The system comprises:
a mobile terminal or User Equipment UE,
a Radio Access Network,
a Core Network including a CS domain (including CS domain entities such as V-MSC (Visited Mobile Switching Center)), an IP network such as IMS network, and at least one interworking entity between CS domain and IP network, including control plane interworking entity such as MGCF (Media Gateway Control Function) and user plane interworking entity such as MGW (Media Gateway). The Core Network also comprises a PS domain, including PS domain entities such as SGSN (Serving GPRS Support Node) and GGSN (Gateway GPRS Support node), and a subscriber database such as HLR (Home Location Register),
a Streaming Server,
a Remote User Agent (RTSP RUA).

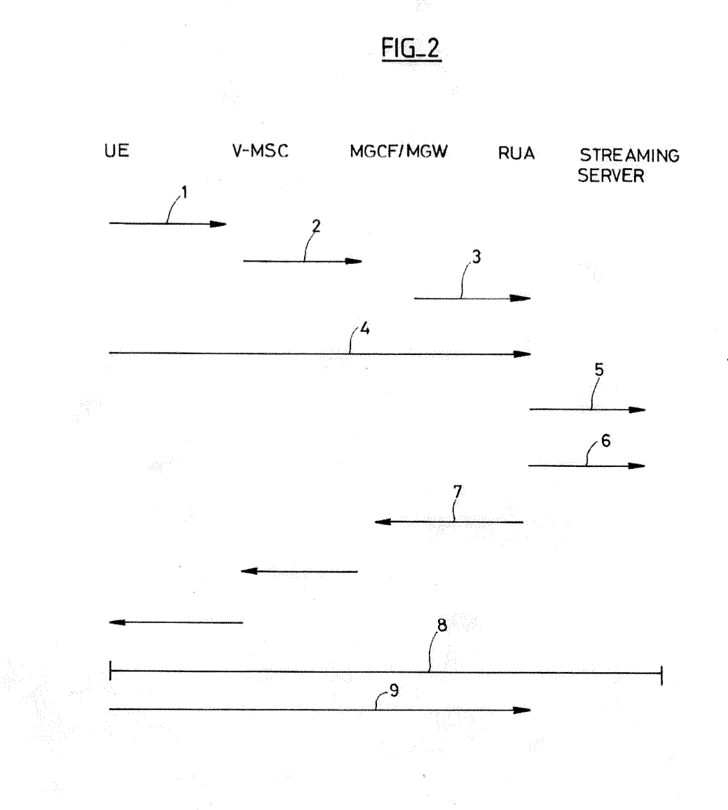

An example of operation of such system is now described using the following phases (or steps as illustrated in FIG. 2).

Phase 1: CS RUA Call Leg Establishment

The UE establishes a CS call towards the RUA (step 1).
The call type is either “voice only” or “multimedia (H.324m/H.223)
The call is propagated toward the MGCF/MGW (step 2)
   In case of CS voice call, a “voice standard” MGCF/MGW is selected to enter the IMS domain
      the MGCF/MGW selects the IP/RTP(RTCP) ports that will anchor the future downstream voice flow before entering the CS domain.
      The MGCF/MGW initiates a INVITE SIP transaction with the RTSP RUA with a SDP offer part comprising these ports and the voice codec allowed (voice codec supported by the terminal, plus those proposed by the MGW if it support transcoding facilities) (step 3)
   In case of CS multimedia call, a MGCF/MGW with enhanced video telephony interworking facilities able to ensure H.245/MONA-SIP/SDP offer interworking is selected by the CS core domain to enter the IMS domain
      The MGCF/MGW selects a couple of IP/RTP(RTCP) ports that will anchor the future voice and video downstream flows before entering the CS domain (step 3)
      The MGCF/MGW initiates a INVITE SIP transaction with the RTSP RUA with a SDP part comprising these couple of ports and the voice and video codecs allowed (voice/video codecs supported by the terminal, plus those proposed by the MGW if it support transcoding facilities).

Phase 2: Acquisition by the Terminal of the Streaming Media Configuration
The UE gets (through different methods like http or I1bis RTSP DESCRIBE method the transport address of the voice and video stream on the streaming server

Phase 3: Connection to Media Streams
The UE can then trigger the RTSP RUA, via I1bis, to send RTSP SETUP message to the streaming server (step 4).
   The triggering I1bis method contains the media(s) type to connect (voice, or voice/video media) and their IP/RTP transport address on the streaming server
The RTSP RUA can then exchange the RTSP SETUP messages with the streaming server (steps 5, 6),
And initiates a SIP INVITE transaction with the MGCF/MGW to indicate the IP/RTP(RTCP) ports of the streaming server and the codec(s) chosen for the session (step 7). The user path between the Streaming server(s) and the terminal is now established for the media(s) and the UE is able to control the streams (step 8).

Phase 4: Streams Control by the UE
During the time life of the streaming session, the UE can trigger via I1bis the RTSP RUA to activate different RTSP methods (PLAY, PAUSE, RECORD . . . ). (step 9)

Phase 5: Termination of the Streaming Session

To terminate the streaming session, the UE, through I1bis, triggers the RTSP RUA to sends RTSP TEARDOWN message to the streaming server.

It can in complement decide to release its RUA connection (that is done automatically if the UE releases the CS call) if it expect not using other streaming immediately.

For I1 bis-CS, the signaling flow is conveyed over the USSD channel that crosses the V-MSC and the HLR. The HLR then conveys I1bis-CS over INAP (Intelligent Network Application Part) towards the RUA (address retrieved in the USSD CSI associated with the user in the HLR).

In another aspect, it is recognized that, if the two RUAs (the RTSP RUA introduced by embodiments of the present invention and the SIP RUA used for ICS purpose) are not integrated, the “SIP CS leg” between the UE and the “SIP RUA” and the “RTSP CS leg” between the UE and the “RTSP RUA” cannot be shared and due to latency of CS establishment, RTSP to SIP switching will not be efficient.

So, more interesting service can be provided (such as for example the above-mentioned surveillance service) if this RTSP RUA function is integrated with the ICS SIP RUA function to form an “enhanced multi protocol RUA”. In this case, the user CS leg from the user to the RUA can be used to both transport TAS flow and streaming flow.

I1 CS or I1 PS (the user interface already defined in 3GPP standard for user interaction with the SIP RUA) can in this case be extended with I1bis CS or I1bis PS primitives. In this case, the above-mentioned phase 1 is common for ICS and RTSP remote CS access.

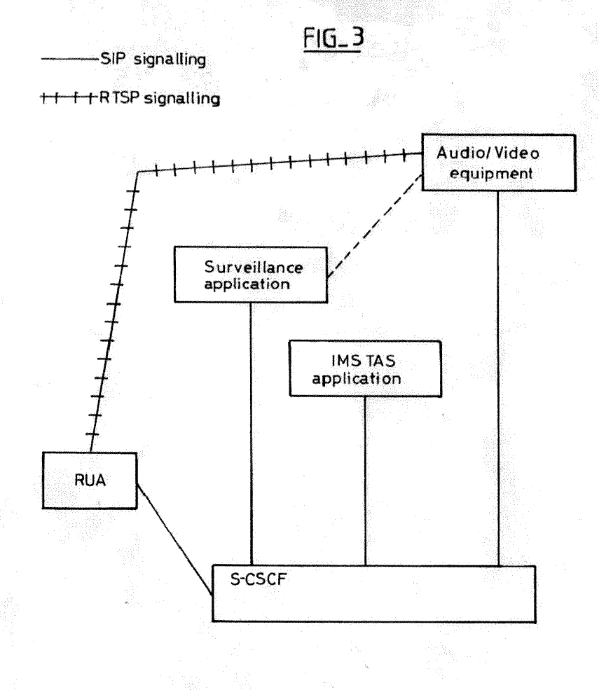

An example of application of embodiments of the present invention, corresponding to audio/video surveillance, is now described in relation with FIG. 3.

In this example the following elements as illustrated in FIG. 3 are used in combination with those illustrated in FIG. 1:
RUA (integrated with the RTSP RUA of FIG. 1)
Audio/Video Equipment (capable of switching from streaming mode to conversational mode)
Surveillance Application Server
IMS TAS Application Server
S-CSCF (Serving-Call Session Control Function)

An example of operation of such system can be described using the following steps:

1) The UE (via the RUA) sends a SIP INVITE message to the Surveillance Application Server with a SDP field mentioning that audio and video are in receiving mode only offer at the terminal side.

2) The Surveillance Application Server understands, as the SDP offer mentions a receiving mode only, that the UE wants to trigger a “streaming session” with the audio/video equipment

3) The Surveillance Application Server sets up the video/audio equipment in “streaming mode configuration” (through a proprietary protocol for example via the dotted line illustrated in FIG. 3)

4) The Surveillance Application Server answers to the SIP INVITE by communicating through a SIP 200 ok the transport IP address of the two streaming audio and video flows

5) The UE can then send SET UP RTSP messages to the audio/video equipment operating in streaming mode (for example to see the exterior of the user's house)

6) When the UE wants to switch to conversational mode (for example because the user wants to dialog with the visitor) the UE sends a new SIP INVITE message to the Surveillance Application Server mentioning that now he/she wants bidirectional media

7) The Surveillance Application Server sets up the audio/video equipment in “videotelephony mode” (for example via the illustrated dotted line) and after acts as a B2B User Agent: it sends a SIP INVITE (that goes through the TAS to the audio/video equipment that answers with a media transport address for upstream flow (the SIP INVITE communicates the IP transport address given by the RUA (IP transport address of the MGW for downstream flow))

8) The Surveillance Application Server relays the SIP ok (from the audio/video equipment) with a SIP ok to the UE (with media IP transport address)

9) The user can then dialog in videotelephony mode with his/her visitor.

Thus, in one aspect, in an embodiment, the present invention provides a method for the delivery of media streaming services to a User Equipment in a mobile communication system having a Core Network comprising a Circuit Switched CS domain, an IP network, and at least one interworking entity between said CS domain and said IP network, said method comprising the steps of:
establishing a call through the CS domain towards a Remote User Agent acting on behalf of the User Equipment in the IP network,
establishing a streaming session with a Streaming Server via the Remote User Agent,
said call establishment interacting with said streaming session establishment to enable the delivery of streaming services to the User Equipment for said streaming session through the CS domain using CS bearer established during said call establishment.

In an embodiment, said method comprises a step of:
controlling the Streaming Server via the Remote User Agent during said streaming session.

In an embodiment, said step of call establishment comprises a step of:
the User Equipment sending to a CS domain entity a request for call establishment, said request including a called number associated with the Remote User Agent.

In an embodiment, said method comprises a step of:
the User Equipment sending to the Remote User Agent information enabling the Remote User Agent to act on behalf of the User Equipment for exchanging messages with the Streaming Server according to a control protocol for media streaming.

In an embodiment, said control protocol for media streaming corresponds to RTSP protocol.

In an embodiment, said said information includes transport address information for sending a request to the Streaming Server according to said control protocol.

In an embodiment, said step of establishing a streaming session via the Remote User Agent comprises a step of:
the Remote User Agent building a request for streaming session establishment, using downstream flow transport termination information at a user plane interworking entity associated with a control plane interworking entity involved in said call establishment, received from said control plane interworking entity, and information enabling the Remote User Agent to act on behalf of the User Equipment, received from the User Equipment.

In an embodiment, said step of interaction between said call establishment and said streaming session establishment comprises a step of:
the Remote User Agent including, in a request for streaming session establishment, media stream transport address information at streaming client side corresponding to downstream flow transport termination information at a user plane interworking entity associated with a control plane interworking entity involved in said call establishment.

In an embodiment, said step of interaction between said call establishment and said streaming session establishment comprises a step of:
the Remote User Agent using codec(s) information for the streaming session, received at call establishment from a control plane interworking entity involved in said call establishment, codec(s) finally negotiated with the streaming server to be included in a response returned to said control plane interworking entity.

In an embodiment, said step of sending information by the User Equipment to the Remote User Agent comprises a step of:
in case the User Equipment can access simultaneously CS domain and PS domain, the User Equipment sending said information to the Remote User Agent via PS domain interworking with the IP network.

In an embodiment, said step of sending information by the User Equipment to the Remote User Agent comprises a step of:
in case the User Equipment cannot access simultaneously CS and PS domain, the User Equipment sending said information to the Remote User Agent via CS domain, using Unstructured Supplementary Service Data USSD.

In an embodiment, said method comprises a step of:
switching a multimedia equipment from a streaming mode wherein streaming services are delivered to the User Equipment according to any of claims 1 to 11, to a conversational mode wherein conversational services are delivered to the User Equipment, or vice versa, depending on user's needs,
in said conversational mode:
   establishing, via the Remote User Agent acting on behalf of the User Equipment, a session for the delivery of said conversational services,
   delivering conversational services to the User Equipment for said session via the CS domain using CS bearer established during said call establishment.

In an embodiment, said method comprises a step of:
the User Equipment sending to the Remote User Agent information enabling the Remote User Agent to act on behalf of the User Equipment for exchanging messages with the multimedia equipment according to an IP-based session control protocol, for said session establishment.

In an embodiment, said IP based session control protocol corresponds to SIP protocol.

In an embodiment, said method comprises a step of:
the User Equipment sending to the Remote User Agent information enabling the Remote User Agent to act on behalf of the User Equipment for exchanging messages, according to an IP-based session control protocol, with an Application Server arranged to control the switching of said multimedia equipment from streaming mode to conversational mode or vice versa.

In an embodiment, said method comprises a step of:
the User Equipment sending to the Remote User Agent information enabling the Remote User Agent to act on behalf of the User Equipment for exchanging messages with said multimedia equipment, according to an IP-based session control protocol, via an Application Server arranged to control the switching of said multimedia equipment from streaming mode to conversational mode or vice versa, and to act as a B2B User Agent for said session establishment.

In another aspect, in an embodiment, the present invention provides a User Equipment, comprising, for the delivery of media streaming services in a mobile communication system having a Core Network comprising a Circuit Switched CS domain, an IP network, and at least one interworking entity between said CS domain and said IP network:
means for establishing a call through the CS domain towards a Remote User Agent acting on behalf of the User Equipment in the IP network,
means for establishing a streaming session with a Streaming Server via the Remote User Agent,
said call establishment interacting with said streaming session establishment to enable the delivery of streaming services to the User Equipment for said streaming session through the CS domain using CS bearer established during said call establishment.

In an embodiment, said User Equipment comprises:
means for sending to a CS domain entity a request for call establishment, said request including a called number associated with the Remote User Agent.

In an embodiment, said User Equipment comprises:
means for sending to the Remote User Agent information enabling the Remote User Agent to act on behalf of the User Equipment for exchanging messages with a Streaming Server according to a control protocol for media streaming.

In an embodiment, said means for sending information by the User Equipment to the Remote User Agent comprise:
in case the User Equipment can access simultaneously CS domain and PS domain, means for sending said information to the Remote User Agent via PS domain interworking with the IP network.

In an embodiment, said means for sending information by the User Equipment to the Remote User Agent comprise:
in case the User Equipment cannot access simultaneously CS and PS domain, means for sending said information to the Remote User Agent via CS domain, using Unstructured Supplementary Service Data USSD.

In another aspect, in an embodiment, the present invention provides a Remote User Agent acting on behalf of a User Equipment in an IP network of a mobile communication system having a Core Network comprising a Circuit Switched CS domain, an IP network, and at least one interworking entity between said CS domain and said IP network, said Remote User Agent comprising, for the delivery of media streaming services through the CS domain using CS bearer established using call establishment through the CS domain towards a Remote User Agent acting on behalf of the User Equipment in the IP network:
means for establishing a streaming session with a Streaming Server via the Remote User Agent,
means for enabling said call establishment to interact with said streaming session establishment to enable the delivery of streaming services to the User Equipment for said streaming session through the CS domain using CS bearer established during said call establishment.

In an embodiment, said Remote User Agent comprises:
means for building a request for streaming session establishment, using downstream flow transport termination information at a user plane interworking entity associated with a control plane interworking entity involved in said call establishment, received from said control plane interworking entity, and information enabling the Remote User Agent to act on behalf of the User Equipment, with information received from the User Equipment.

In an embodiment, said Remote User Agent comprises:
means for including, in a request for streaming session establishment, media stream transport address information at streaming client side corresponding to downstream flow transport termination information at a user plane interworking entity associated with a control plane interworking entity involved in said call establishment.

In an embodiment, said Remote User Agent comprises:
means for using codec(s) information for the streaming session, received at call establishment from a control plane interworking entity involved in said call establishment, codec(s) finally negotiated with the streaming server to be included in a response returned to said control plane interworking entity.

The detailed implementation of the above-mentioned means does not raise any special problem for a person skilled in the art, and therefore such means do not need to be more fully disclosed than has been made above, by their function, for a person skilled in the art.

1. A method for the delivery of media streaming services to a User Equipment in a mobile communication system having a Core Network comprising a Circuit Switched CS domain, an IP network, and at least one interworking entity between said CS domain and said IP network, said method comprising the steps of:
establishing a call through the CS domain towards a Remote User Agent acting on behalf of the User Equipment in the IP network,
establishing a streaming session with a Streaming Server via the Remote User Agent,
said call establishment interacting with said streaming session establishment to enable the delivery of streaming services to the User Equipment for said streaming session through the CS domain using CS bearer established during said call establishment.

2. A method according to claim 1 comprising a step of:
controlling the Streaming Server via the Remote User Agent during said streaming session.

3. A method according to claim 1, wherein said step of call establishment comprises a step of:
the User Equipment sending to a CS domain entity a request for call establishment, said request including a called number associated with the Remote User Agent.

4. A method according to claim 1, comprising a step of:
the User Equipment sending to the Remote User Agent information enabling the Remote User Agent to act on behalf of the User Equipment for exchanging messages with the Streaming Server according to a control protocol for media streaming.

5. A method according to claim 4, wherein said control protocol for media streaming corresponds to RTSP protocol.

6. A method according to claim 4, wherein said information includes transport address information for sending a request to the Streaming Server according to said control protocol.

7. A method according to claim 1, wherein said step of establishing a streaming session via the Remote User Agent comprises a step of:
the Remote User Agent building a request for streaming session establishment, using downstream flow transport termination information at a user plane interworking entity associated with a control plane interworking entity involved in said call establishment, received from said control plane interworking entity, and information enabling the Remote User Agent to act on behalf of the User Equipment, received from the User Equipment.

8. A method according to claim 1, wherein said step of interaction between said call establishment and said streaming session establishment comprises a step of:
the Remote User Agent including, in a request for streaming session establishment, media stream transport address information at streaming client side corresponding to downstream flow transport termination information at a user plane interworking entity associated with a control plane interworking entity involved in said call establishment.

9. A method according to claim 1, wherein said step of interaction between said call establishment and said streaming session establishment comprises a step of:
the Remote User Agent using codec(s) information for the streaming session, received at call establishment from a control plane interworking entity involved in said call establishment, codec(s) finally negotiated with the streaming server to be included in a response returned to said control plane interworking entity.

10. A method according to claim 4, wherein said step of sending information by the User Equipment to the Remote User Agent comprises a step of:
in case the User Equipment can access simultaneously CS domain and PS domain, the User Equipment sending said information to the Remote User Agent via PS domain interworking with the IP network.

11. A method according to claim 4, wherein said step of sending information by the User Equipment to the Remote User Agent comprises a step of:
in case the User Equipment cannot access simultaneously CS and PS domain, the User Equipment sending said information to the Remote User Agent via CS domain, using Unstructured Supplementary Service Data USSD.

12. A method according to claim 1, comprising a step of:
switching a multimedia equipment from a streaming mode wherein streaming services are delivered to the User Equipment, to a conversational mode wherein conversational services are delivered to the User Equipment, or vice versa, depending on user's needs,
in said conversational mode:
establishing, via the Remote User Agent acting on behalf of the User Equipment, a session for the delivery of said conversational services,
delivering conversational services to the User Equipment for said session via the CS domain using CS bearer established during said call establishment.

13. A method according to claim 12, comprising a step of:
the User Equipment sending to the Remote User Agent information enabling the Remote User Agent to act on behalf of the User Equipment for exchanging messages with the multimedia equipment according to an IP-based session control protocol, for said session establishment.

14. A method according to claim 13, wherein said IP based session control protocol corresponds to SIP protocol.

15. A method according to claim 12, comprising a step of:
the User Equipment sending to the Remote User Agent information enabling the Remote User Agent to act on behalf of the User Equipment for exchanging messages, according to an IP-based session control protocol, with an Application Server arranged to control the switching of said multimedia equipment from streaming mode to conversational mode or vice versa.

16. A method according to claim 12, comprising a step of:
the User Equipment sending to the Remote User Agent information enabling the Remote User Agent to act on behalf of the User Equipment for exchanging messages with said multimedia equipment, according to an IP-based session control protocol, via an Application Server arranged to control the switching of said multimedia equipment from streaming mode to conversational mode or vice versa, and to act as a B2B User Agent for said session establishment.

17. A User Equipment, comprising, for the delivery of media streaming services in a mobile communication system having a Core Network comprising a Circuit Switched CS domain, an IP network, and at least one interworking entity between said CS domain and said IP network:
means for establishing a call through the CS domain towards a Remote User Agent acting on behalf of the User Equipment in the IP network,
means for establishing a streaming session with a Streaming Server via the Remote User Agent,
said call establishment interacting with said streaming session establishment to enable the delivery of streaming services to the User Equipment for said streaming session through the CS domain using CS bearer established during said call establishment.

18. A User Equipment according to claim 17, comprising:
means for sending to a CS domain entity a request for call establishment, said request including a called number associated with the Remote User Agent.

19. A User Equipment according to claim 17, comprising:
means for sending to the Remote User Agent information enabling the Remote User Agent to act on behalf of the User Equipment for exchanging messages with a Streaming Server according to a control protocol for media streaming.

20. A User Equipment according to claim 19, wherein said means for sending information by the User Equipment to the Remote User Agent comprise:
in case the User Equipment can access simultaneously CS domain and PS domain, means for sending said information to the Remote User Agent via PS domain interworking with the IP network.

21. A User Equipment according to claim 19, wherein said means for sending information by the User Equipment to the Remote User Agent comprise:
in case the User Equipment cannot access simultaneously CS and PS domain, means for sending said information to the Remote User Agent via CS domain, using Unstructured Supplementary Service Data USSD.

22. A Remote User Agent acting on behalf of a User Equipment in an IP network of a mobile communication system having a Core Network comprising a Circuit Switched CS domain, an IP network, and at least one interworking entity between said CS domain and said IP network, said Remote User Agent comprising, for the delivery of media streaming services through the CS domain using CS bearer established using call establishment through the CS domain towards a Remote User Agent acting on behalf of the User Equipment in the IP network:
means for establishing a streaming session with a Streaming Server via the Remote User Agent,
means for enabling said call establishment to interact with said streaming session establishment to enable the delivery of streaming services to the User Equipment for said streaming session through the CS domain using CS bearer established during said call establishment.

23. A Remote User Agent according to claim 22, comprising:
means for building a request for streaming session establishment, using downstream flow transport termination information at a user plane interworking entity associated with a control plane interworking entity involved in said call establishment, received from said control plane interworking entity, and information enabling the Remote User Agent to act on behalf of the User Equipment, with information received from the User Equipment.

24. A Remote User Agent according to claim 22, comprising:
means for including, in a request for streaming session establishment, media stream transport address information at streaming client side corresponding to downstream flow transport termination information at a user plane interworking entity associated with a control plane interworking entity involved in said call establishment.

25. A Remote User Agent according to claim 22, comprising:
means for using codec(s) information for the streaming session, received at call establishment from a control plane interworking entity involved in said call establishment, codec(s) finally negotiated with the streaming server to be included in a response returned to said control plane interworking entity.
